(19) United States
(12) Patent Application Publication
(10) Pub. No.: US 2007/0150163 A1
(43) Pub. Date: Jun. 28, 2007

(54) Web-based method of rendering indecipherable selected parts of a document and creating a searchable database from the text

(76) Inventor: David J. Austin, Philadelphia, PA (US)

Correspondence Address: Donald C. Simpson, Esq., 126 Borton Landing Road, Moorestown, NJ, 08057-3055, US

(21) Appl. No.: 11/398,110

(22) Filed: Apr. 5, 2006

Related U.S. Application Data
(63) Continuation-in-part of application No. 11/320,203, filed on Dec. 28, 2005.

(51) Int. Cl. G06F 19/00

(52) U.S. Cl. 701/102

(57) ABSTRACT

A method and apparatus for uploading and storing a document created in a word processing program (such as MS Word, Claris Works, WordPad, WordPerfect, etc.) onto a networked server in a way that preserves the “look and feel” of the uploaded document and allows users to select, classify, and conceal various blocks of text contained within the document so that a confidential or secure version of the document can be displayed on the Internet and the classified blocks of text can become the basis of a searchable computer database.

### RELATED APPLICATIONS

This application is a continuation-in-part of U.S. patent application Ser. No. 11/320,209 filed Dec. 28, 2005.

### FEDERALLY SPONSORED RESEARCH

This invention was not the subject of any federally sponsored research or development.

### FIELD OF THE INVENTION

This invention relates to the field of Internet Commerce where computers are used to distribute and/or sell computer-generated documents over the Internet (e.g. Resumes, Financial Reports, Medical Reports, Studies, Books, etc.)

### BACKGROUND OF THE INVENTION

Many individuals, companies, and institutions today have an almost endless need to obtain and disseminate documents that may contain certain types of confidential information. Typical examples of these documents are financial reports, medical reports, bank account statements, stock quotes, benefit plans, news articles, technical articles, service bulletins, book reviews, maps, charts, resumes, or any other document where the information contained in that particular document has some value to the client.

In order to reduce costs, companies have understandably looked for less expensive ways of distributing important documents to their clients upon request. One such way is by making the documents available on the Internet. However, since the Internet is a public medium, unguarded documents placed on the Internet could be easily viewed by anyone. This is highly unsatisfactory when some of the information contained in the document may be confidential or when the company desires payment before releasing the information of interest to the client.

To prevent random and unauthorized access to these documents over the Internet, companies and institutions have instituted a system where the client must first open an account consisting of a user name, a password, and a PIN number which enables him to enter the website that contains the desired documents and view what he is looking for. This system works sufficiently well for documents like bank or credit card statements where there is only one source for the document (the bank) and only one client (the customer) and the client knows exactly what he is looking for. It is relatively easy to maintain such a system because the source and content of the document is known in advance and the targeted viewer of the document is also known in advance.

But there are many instances in which the documents would need to be submitted from many diverse sources and the owners of these documents would like to exercise control over what confidential information is released over a public network like the Internet. Clients, on the other hand, would like the ability to peruse a copy of the document such that it preserves the “look and feel” of the original document when searching for pertinent information even though they understand that some of the vital information may be rendered indecipherable. This is because clients often believe that the “look and feel” of the document also has some value in addition to the content. In cases like this, it becomes exceedingly difficult to provide a system that achieves these goals.

For example, consider a system in which resumes are posted on the Internet. Many websites collect resumes over the Internet then sell them back to employers seeking job candidates. But since these resumes contain personal information like the owner's identity and place of work, many job candidates are understandably reluctant to make this information available on a medium they have no control over due to the epidemic of recent “identity theft” cases. If, on the other hand, the job candidate chooses to upload a resume that has the personal information excluded, then the resume would have no value to a potential employer because he would have no way of knowing the identity of the job candidate and contacting him. Resume websites and recruiters have struggled with this problem for as long as the Internet has been in existence, but as of the present, there is still no satisfactory way of dealing with this. The section on Prior Art describes some of the previous and current methods that attempt to deal with security and other issues.

What is needed therefore is a simple and reliable method and system in which the originator of any document (such as a resume) could exercise control over which parts of the document remain visible and which parts are rendered indecipherable over an Internet link while, at the same time, preserving the “look and feel” of the original document so that a client, also on the Internet, is able to search for vital information and keywords on these documents.

### DESCRIPTION OF THE PRIOR ART

While this invention is applicable to any type of a document, consider the case of a resume listed on an Internet website since this is a particularly good example of the utility of this invention.

In a typical example of the prior art, the job candidate opens an Internet account, fills in some text boxes with pertinent personal information, then uploads his resume to the hosting website where it is stored on a server along with the pertinent personal information. Some websites vary from this basic format by requiring more or less information, but by and large, the basic functions remain the same. For instance, some websites require the job candidate to fill in some supplementary text boxes with additional job-related information such as job title, experience, education, salary requirements, etc. while others rely entirely on the text boxes and do not allow the uploading of the actual resume. Still others rely entirely on the uploaded resume and require no additional information. Fundamentally, these all serve the same purpose of storing a resume (or the equivalent of a resume) on a computer server and make it available to employers to look at for a fee. In order to maintain confidentiality and to protect the job candidate's identity, some web sites advise the candidate to delete the contact information and the current place of employment. The web site must then require the candidate to fill in some text boxes with personal and contact information to enable the employer to contact the candidate. The information in the text boxes is stored on a server and associated with the resume.

Typically, to use the service, an employer opens an account, pays (or agrees to pay) a fee, then is permitted to enter some search terms to narrow down his search to an applicable job candidate. The server then uses the search terms to search through the database to locate the best match to the employer's criteria.

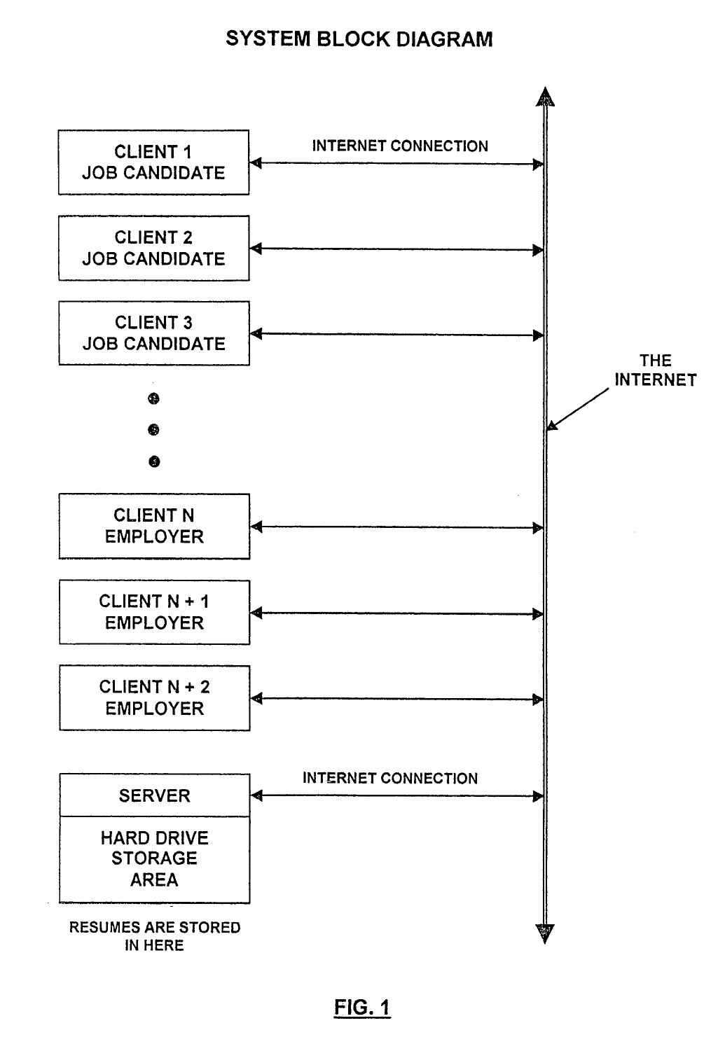

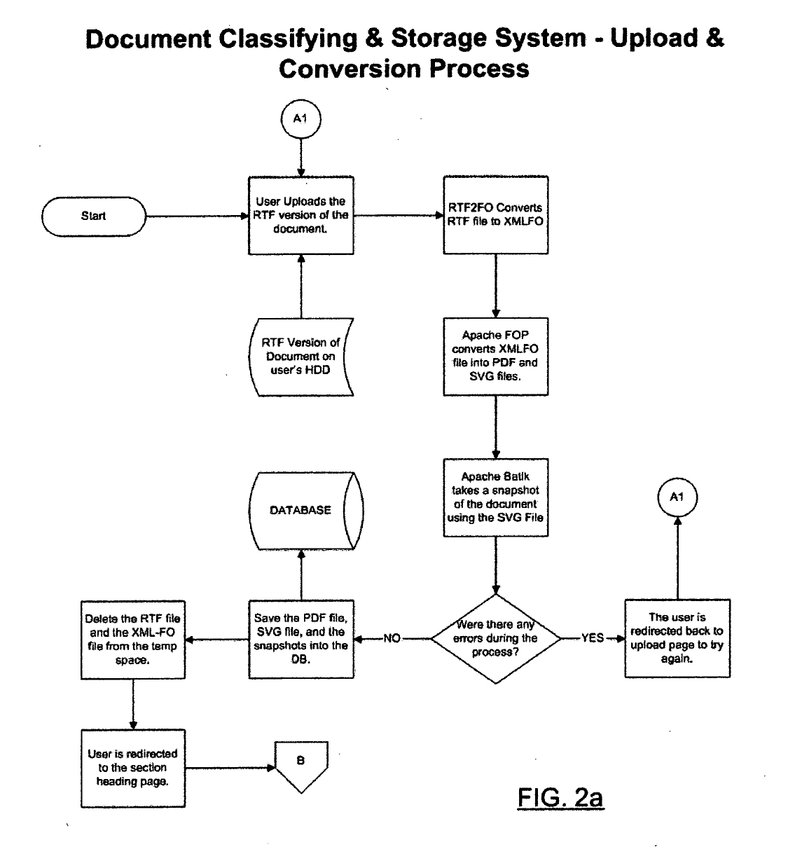

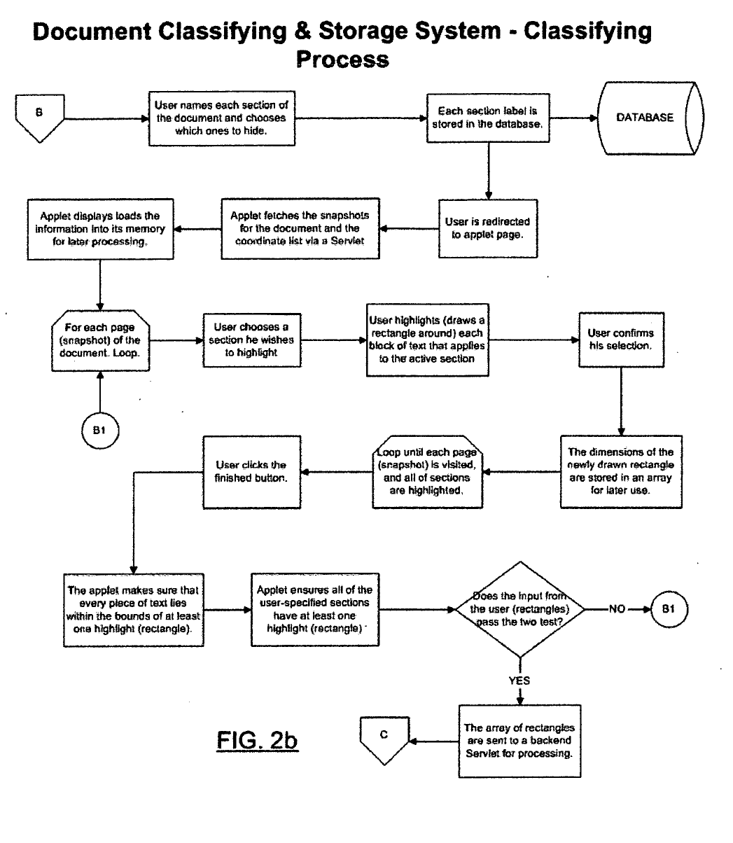

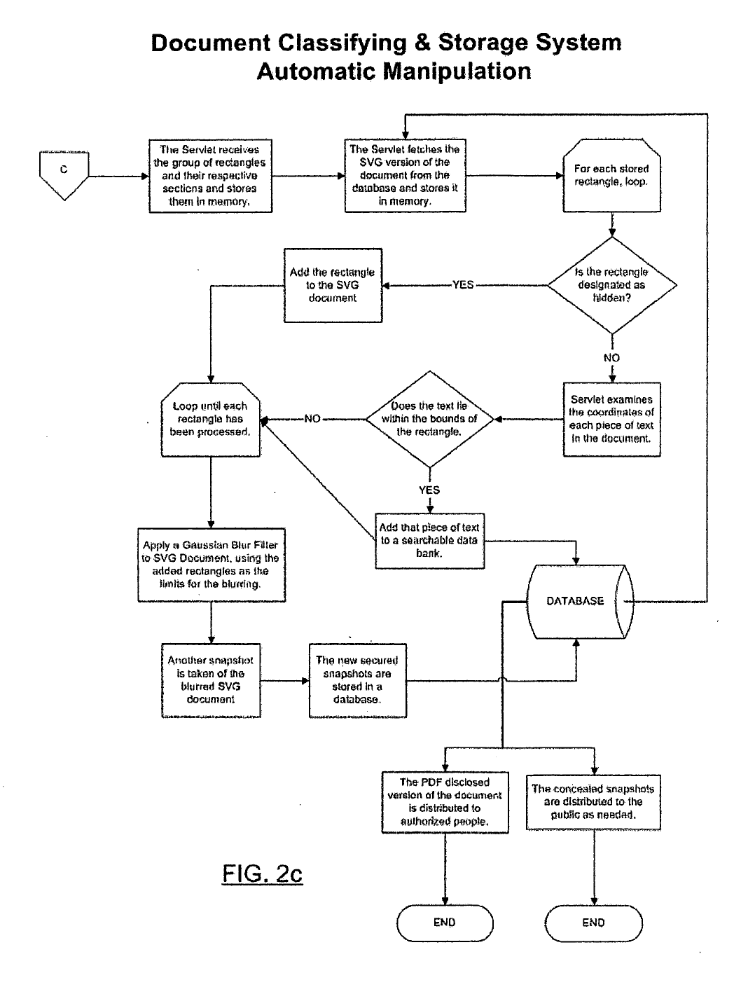

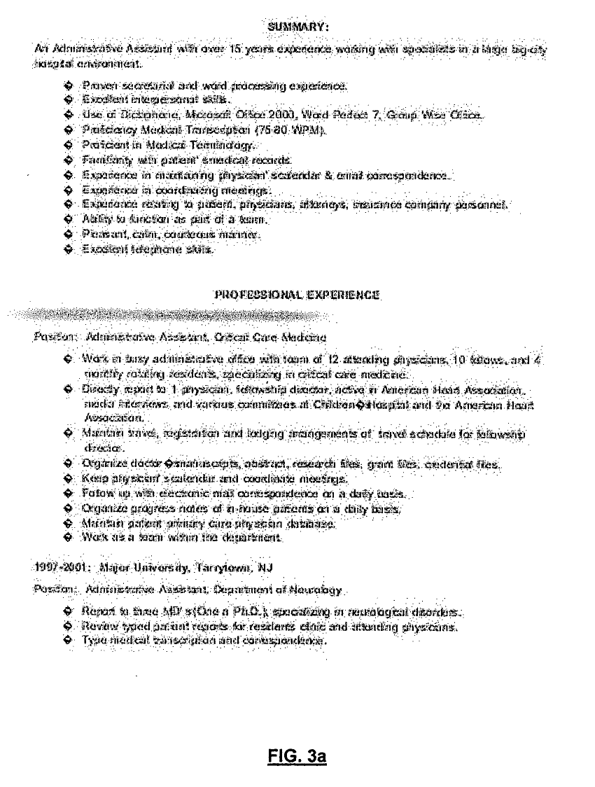

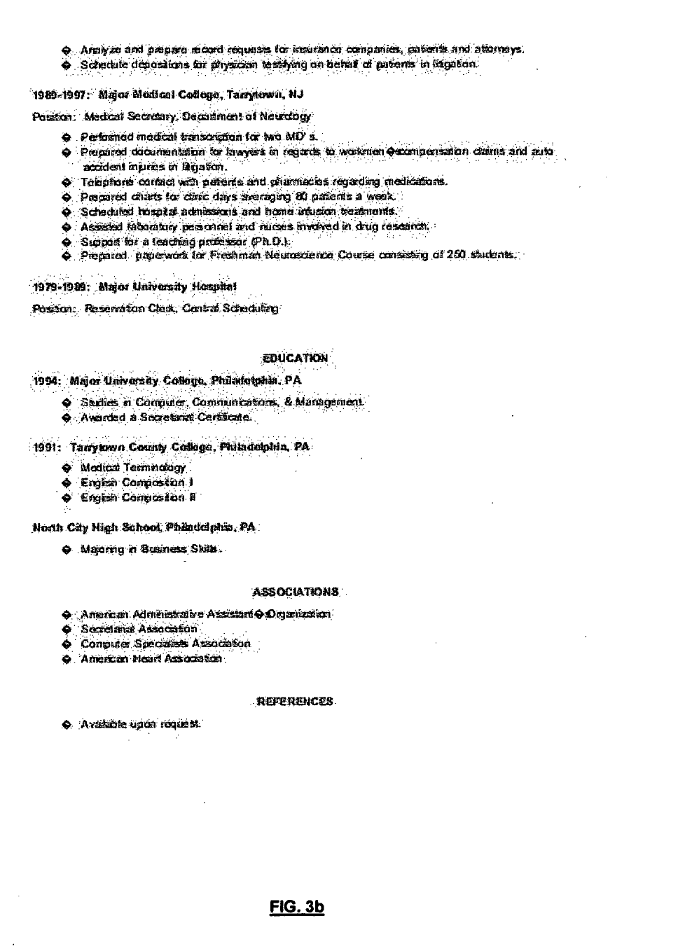

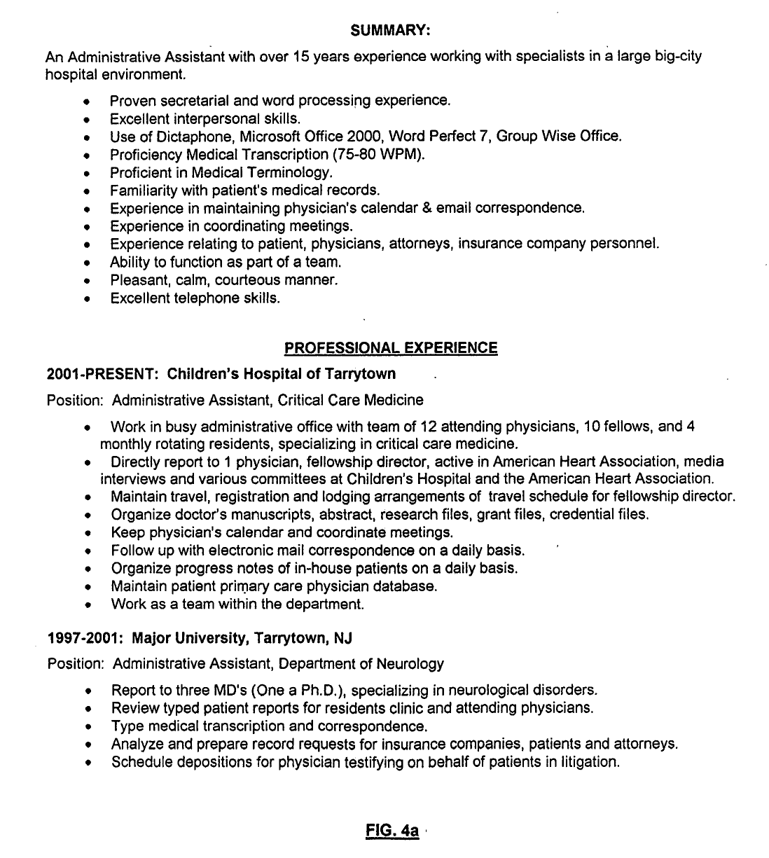

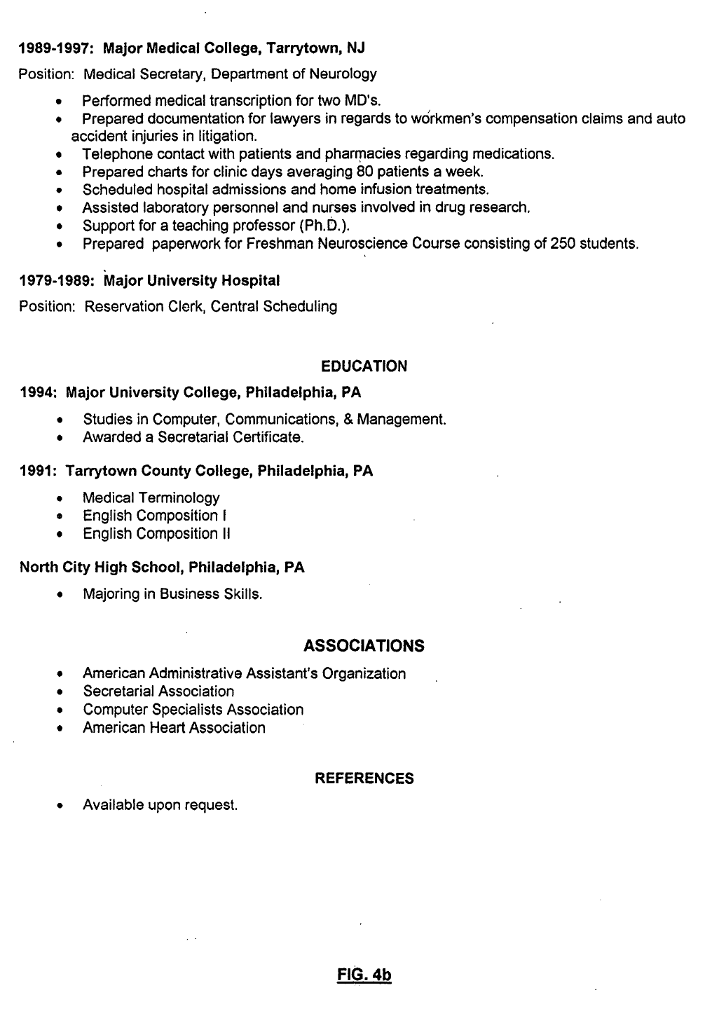

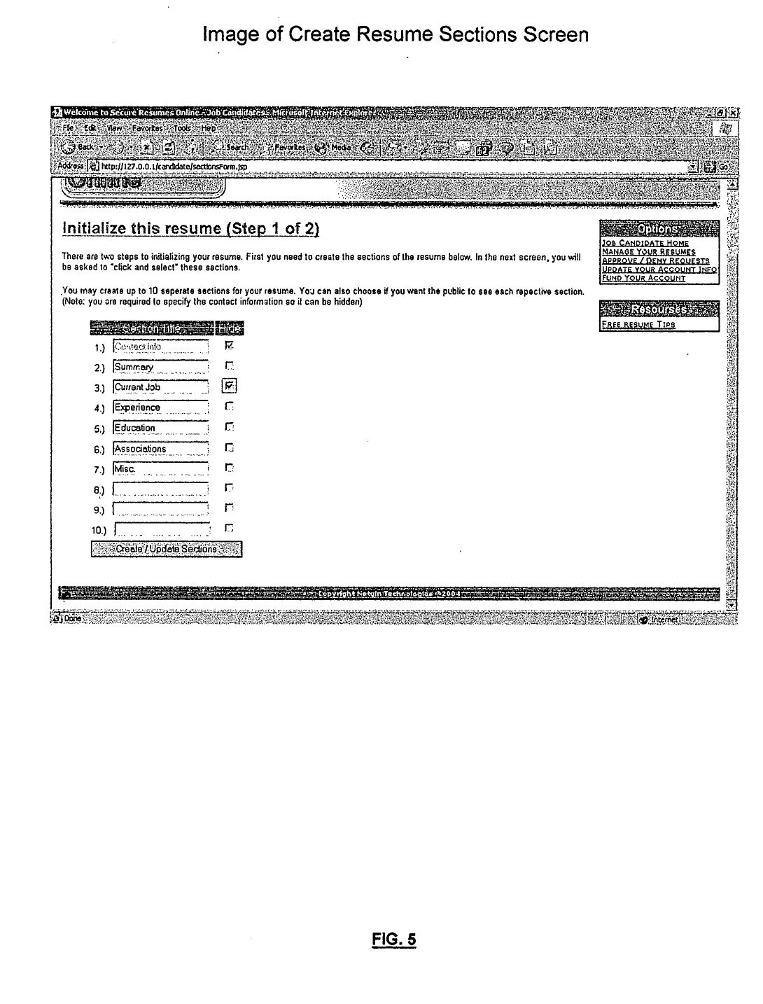

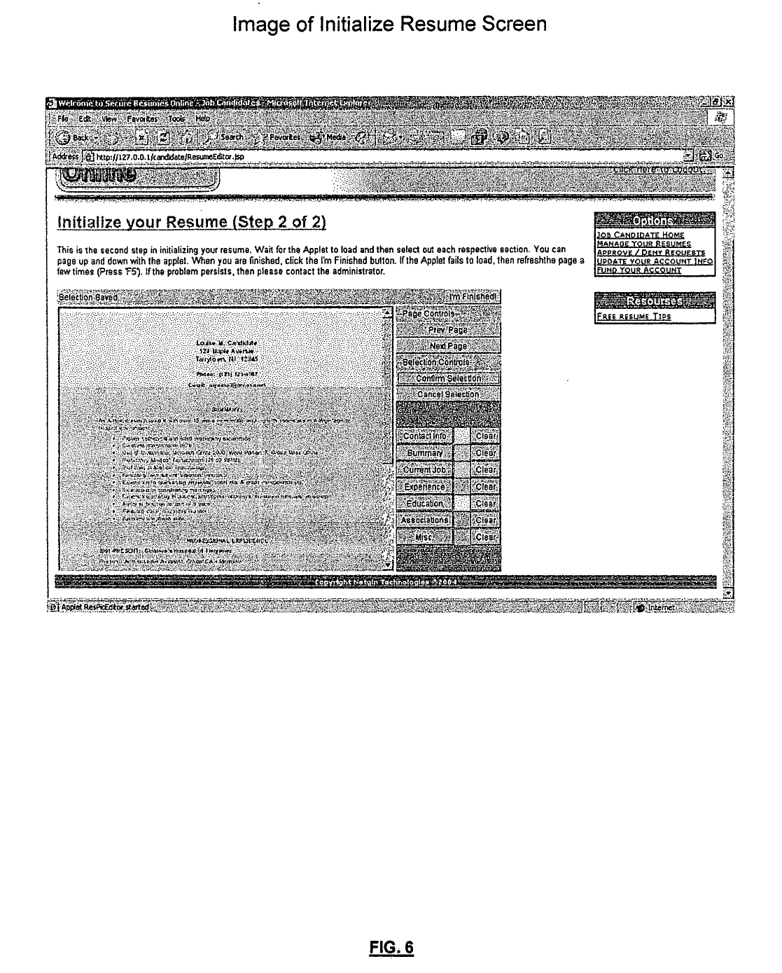

U.S. Pat. Nos. 5,758,324, 6,564,188, 6,718,340, and 6,718,345 describe a system for the storage and retrieval of resumes. These patents acknowledge that there is value in preserving the “look and feel” of the original document but require the job candidate to fill in some text boxes on what is called a “Resume Outline Form”. The form is depicted in U.S. Pat. No. 6,718,345 as FIGS. 3, 4, and 5. This is necessary because, in their system, there is no way to extract the personal contact information directly from the resume image. In fact, the patents clearly state: “The form is useful in that it provides searchable information. The information of the graphics file cannot be easily searched”. This is because many English words and abbreviations are spelled alike but mean different things based on the context of the sentence. The search engine is often fooled by look-alike words thus giving many false positives or misses words that are misspelled. This emphasizes one of the major problems with the prior art, that is, to provide an accurate and meaningful search of keywords on a resume located in a database. Therefore, without the text boxes there would be no way of contacting the Job Candidate if he chose to leave off the contact information on his resume to protect his identity from possible identity theft.

### PROBLEMS WITH THE PRIOR ART

The problems with the current technology are as follows:

First, the mechanisms that are used to capture supplementary information about resumes over the Internet are tedious and cumbersome to use. For example, if the listing service wishes to create a searchable database of the candidate's skills along with each resume, the job candidate would manually have to type this information into a textbox or fill out a form for submission. This would be required for virtually all the classifications on a resume such as experience, education, etc. Currently, with the prior art, there is no fast and easy way to extract this kind of information easily and directly from an uploaded resume with just a few clicks of a computer mouse in order to provide for a searchable database.

Second, with the prior art, there is no good way for an employer to view the “look and feel” of the actual resume while at the same time protecting the job candidate's identity. The prior art offers either the full original version of the resume, a version of the resume with contact information excluded, or a summary outline form of the candidate's qualifications (that is, prior to payment of a fee). Currently, with the prior art, there is no easy way (that is, from within a website application) for a job candidate to render indecipherable any personal information that he or she does not want displayed on the Internet while preserving the “look and feel” of the original resume.

Third, with the prior art, there is no way of recovering any personal or confidential information that was deleted by the job candidate from an uploaded resume in order to protect his or her identity. Current resume listing services depend on ancillary text boxes for the missing information. If the employer wanted to see a full-uncut version of the job candidate's resume, the employer would first have to contact the candidate, then the candidate would either have to email it to him or delete the original one displayed on the website and upload a new one with missing information intact. This, of course, would be visible to everyone on the Internet and compromise his confidentiality. Currently, the prior art does not enable the missing information to be recovered and inserted automatically and directed only to specific employers. Therefore, the job candidate would have to email it (or mail it by the US Postal Service) directly to the employer to maintain confidentiality. If there were multiple potential employers, the candidate would have a considerable amount of additional work to do which might cost him a job offer if he delayed and someone else responded faster.

Fourth, in some embodiments of the prior art (U.S. Pat. Nos. 5,758,324, 6,564,188, 6,718,340, and 6,718,345), the job candidate needs to convert and upload his resume to the server in the form of a graphics file where it is stored. It is very explicit in that it be in the form of a graphics file such as a .GIF, .TIF, .JPG, .BMP, .TGA, .EPS, .PCX or any other form of a graphics file where it is stored on the server. These patents state that the job candidate typically uses a scanner or fax machine to create the graphics file but could also send a paper copy of the resume to the system administrator who will perform the conversion to a graphics file. The requirement to convert it to a graphics file can become a burden to someone who does not have access to a scanner or fax. Also, there is no easy way to go directly from a text file to a graphics file within most industry-standard word processing programs. Therefore, eliminating the requirement for the job candidate to convert it to a graphics file would be a big improvement in facilitating the uploading of a resume for storage and retrieval on a server.

It is apparent that the prior art has not anticipated a system whereas confidential documents can be uploaded and disseminated over an Internet link in such a manner that preserves the “look and feel” of the document while rendering the confidential parts indecipherable and provides for a method of creating a searchable database of the text located within the document. It also has not anticipated a system whereas the original (unmasked) document can be recovered at a later time and displayed over the Internet upon completion of some requirement such as payment of a fee.

It is obvious that (in the case of a resume) such a system would be highly advantageous to both the job candidate and to the employer.

### SUMMARY OF THE INVENTION

This invention describes a new and novel way of uploading a document created in a word processing program (such as MS Word, Claris Works, WordPerfect, or WordPad) onto a server where the document would be further processed such that it would then be automatically converted into a picture that would maintain the look and feel of the document while the text within the document is stored in a database for search purposes. Along with each piece of text that is stored (i.e. a word, number, email address), the coordinates where that piece of text can be found on the picture would be stored so the text could easily be associated with points on the picture. This would allow an Internet user to be presented with a web graphic representation of the document that is enclosed in a browser plug-in (such as a java applet, or active-x executable) GUI (Graphical User Interface). The GUI would have the ability to capture the coordinates of successive selections made by the user via mouse movements. The GUI could then retrieve the text associated with the user's selections by looking up the stored coordinates of the text and comparing them with the user's mouse movements. The GUI could perform a manipulation of the graphic as well as a manipulation of the text within the document. This would allow the GUI to render certain parts of the graphic indecipherable (i.e. blurring out the text), as well as preventing the text from the corresponding parts of the document from being searched. Also, sections of the text could be classified or associated with a title or heading such that the text within the boundaries (i.e. the coordinates) of that heading now become the basis of a searchable database. Because the context of the text is anticipated and known, the text now becomes a very effective searchable database. This reduces the incidence of false positives and significantly enhances the accuracy of a keyword search. The invention also provides for a method and system to recover the unmasked original version of the document and display it over a secure Internet link to selected users at a later time upon completion of some requirement such as the payment of a fee.

### OBJECTIVE

The primary purpose of this invention is to make it as easy as possible for job candidates to upload their resumes to a resume listing service, make these resumes available to potential employers over an Internet link with the least amount of hassle to the employer, and minimizing or eliminating the possibility of identity theft. It is also an objective of this invention to provide employers with a searchable database of actual resumes where the “look and feel” of the original resume is preserved.

Although the included examples and much of the description has been centered around resumes, the technology could equally well be used for resume cover letters, financial reports, medical reports, bank account statements, stock quotes, benefit plans, news articles, technical articles, service bulletins, book reviews, maps, charts, or any other application which requires a searchable database and where the “look and feel” of the document is desired to be preserved without revealing certain portions of the document to unauthorized persons.
Another use for this invention would be for the listing of jobs in the case where the employer desired to maintain his identity confidential. In this case, the roles of the employer and the job candidate would be reversed such that the employer would be posting a job and the job candidate would be contacting the employer for his identity and the employer could decide who to release his identity to by accepting or denying the request.

### BRIEF DESCRIPTION OF THE DRAWINGS

The figures, in numerical order, are as follows:

1. Block diagram of typical system.

2. Flow chart of Applet
a. Document Classifying & Storage System—Upload and Conversion Process
b. Document Classifying & Storage System—Classifying Process
c. Document Classifying & Storage System—Automatic Manipulation

3. Image of blurred out sample resume. (a and b)

4. Image of same resume as above but without masking. (a and b).

5. Image of Create Resume Sections screen.

6. Image of Initialize Resume screen.

### DETAILED DESCRIPTION OF THE INVENTION

This description describes an applet. An applet is a program that is run from within another program to perform a specific function. Because applets are generally small in size, compatible with multiple operating systems, and highly secure, they are ideal for small Internet applications accessible from a web browser.

(1) Uploading & Converting the Word-Processing Document

The document uploading process is simple. The user is instructed to save his document in Rich Text Format (RTF) format. This is easily done within any word processing application. The user is then prompted with an HTML data entry interface to browse to the document's file (which normally resides on the user's hard drive) on the client's computer. The user then clicks the button and the document begins to upload.

It is important that the user in the word-processing program first save the document file as Rich Text Format (RTF). RTF is a universal file format that is used by every major word processing program (i.e. MS Word, Claris Works, Lotus, etc.). We impose this restriction on the file format (in the preferred embodiment) to make the system as universal as possible. Windows, Linux, and Mac users can easily save their documents in RTF with even the most basic word processing programs. Therefore, use of this application is not limited to any particular computer or operating system currently available or planned for the future.

Note: While the type of file format specified in the preferred embodiment of the invention is RTF, it would be obvious to anyone skilled in the art to recognize that other text-based file formats such as can be generated by Microsoft Word, Notepad, WordPad, HTML, WordPerfect, Claris Works, Lotus, Word for Macintosh, Works for Windows, Adobe, etc., resulting in file extensions such as but not limited to: .doc, .txt, .htm, .dot, .asc, ans, .mcw, .wps, .pdf, or any other text-based format would work equally well and could just as easily be used without departing from the spirit and functionality of the invention.

As the file is being uploaded, it is checked for viruses and other undesirable embedded programs. After the file is uploaded, it is temporarily saved on the server's hard drive where the conversion code can begin processing the file. The RTF file is read into the conversion program (RTF2FO supplied by Novasoft, inc.) and converted into the proprietary markup language known as XML (Extensible Markup Language). More specifically, it is converted into a type of XML called a Formatting Object (FO).

This XML-FO file can now be used as a base for other conversions as needed. There are two other text-formats that the XML-FO file is immediately converted into: PDF (Portable Document Format) and SVG (Scalable Vector Graphics). These conversions are done using a prepackaged library called FOP (Formatting Object Processor) supplied from Apache, Inc. The PDF version of the document is stored in the database as the full version of the document. PDF is an industry standard for distributing word-processing documents over the Internet. We are storing a copy in PDF format so that authorized people can have access to the disclosed document in a usable and distributable format that can be easily saved, resized, and printed as needed.

The second format that the XML-FO is converted into is SVG. SVG is a unique subset of XML in that it stores graphical characteristics of the document, as well as the text-information contained within. For instance, the SVG version of the document will store the coordinates where each piece of text can be found on the layout of a page, as well as the text size and shape, and also layout elements like margins, tab spaces, etc. It basically describes how the text of the document should look on the page in addition to storing the actual text information.

Another software package called “Batik” (also from Apache, Inc) is used to take a “snapshot” of how the document would look if it were printed out. This snapshot is rendered as a pure pixilated graphics file (with no text behind the scenes). The graphics file format that is used is JPG (The Jpeg industry standard). A “snapshot” is taken of each page of the document, via the Batik library routines used in conjunction with the SVG version of the document.

Each graphics file that is produced from this “snapshot” process is stored in a database along with the SVG and PDF files that were produced in the conversion process. The original uploaded RTF file, and the XML-FO file that was created for the initial conversion are not used and are deleted.

Even though this process sounds lengthy, it is very fast, taking only a few seconds or less of server processing time. The user is now redirected to a web page where he can choose which sections of the document that are to be classified.

(2) Classifying the Document

Once the word-processing document is converted and filtered into the database, and if there are no errors, the user can now classify and conceal parts the document. Classifying means to associate user-selected parts of the text to a heading (i.e. title or label). The heading can be either user-selected or pre-assigned by the website. For example, “Education” can be a heading. This is facilitated with a Java applet, and active-x control, or any other web browser plug-in that can manipulate pictures and communicate via http. For our purposes, we used a Java applet.

Before the user is presented with the applet, he must name the various sections of the document and choose whether or not to hide each one. For instance, if the user were trying to classify and conceal parts of a resume, he would name some common areas of the resume like Contact Information, Objective, Skills, Experience, etc. If the user were trying to conceal parts of a report, he may specify Title, Abstract, Body, and Facts & Figures as possible sections. This is done via text boxes that are filled out on a web page, which are submitted and entered into the database upon completion. He also declares which of the specified sections are to be hidden.

Now that the possible sections are identified, he can go on to match the parts of the document with their respective sections. At this time, the user is redirected to a web page that contains the Java applet.

The Java applet is the GUI that the user uses to select out the various sections of the document, including the hidden ones. When the applet program loads into memory, it connects to a specialized http interface, called a Servlet, in order to get the information it needs to display a picture (snapshot) of the document to the user and also to learn the position of each piece of text in the picture.

More specifically, the applet initially connects to a Servlet and loads the snapshots of each page of the document into memory for display to the user. At that time, that applet also downloads a list of coordinates of each piece of text and stores that list as an array for use within the GUI. Note that all communication between the applet and the Servlet is protected with encryption and verified with session cookies.

GUI is comprised of a main display area (called a Canvas) that is used to show each page (as a picture) of the document as well as capture mouse movements over that page. Along with the display canvas, the GUI has a set of buttons in the margin. Those buttons include a <FINISHED> button that the user clicks when he is finished classifying the document, and a set of <PAGE UP> and <PAGE DOWN> buttons. There are also buttons that the user clicks to confirm the current selection and to undo the previous selection. In the margin also exist sets of buttons for each previously defined sections. Each set is comprised of one button to switch on the selection process for the respective section and also another button to delete all of the selections the user has already made for the respective section.

So when the user is presented with this applet, he first clicks on the button representing the section he wishes to categorize the text into. Then, using the mouse, he draws a rectangle around the text on the picture of the document that is supposed to be associated with that section. After the rectangle is drawn, he pushes <CONFIRM> to save that rectangle. He can draw as many rectangles as he needs to for that section. After he is finished categorizing the text into the first section, he then clicks the button that corresponds to another section, and draws rectangles over the text for that section. He repeats this process until all the text is classified into their respective sections. He also repeats this process for each additional page of the document. Note that each different section of the document will have its own group of colored rectangles. Each section has its own unique color. The colors are translucent, so it may appear to the user that the text is actually being highlighted. When the user is finished and if he has performed the functions correctly, all of the text in the document will belong to a particular and unique section.

It is important to note what happens behind the scenes when the user highlights (draws rectangles around) the text that appears on the picture of the document. Every rectangle that the user draws has coordinates and dimensions that define that rectangle. These dimensions are stored in an array and associated with the section for later use.

(3) Testing the Document

After the user is finished highlighting the text, he will click the <I'M FINISHED> button using the mouse. When the <I'M FINISHED> button is clicked, there are three tests that run on the user's input.

First, the applet tests that there is at least one piece of text in every section. In other words, the user has drawn at least one rectangle for every defined section. This ensures that every section that the user originally specified is actually needed and that none of the sections were forgotten.

Second, the applet checks to see if every piece of text is contained in at least one section. In other words, every piece of text on the picture of the document has to be highlighted (i.e. none of the text can remain un-classified). This is to ensure that there is are no words or phrases in the document that are not associated with a section.

Third, in the case of resumes, the applet checks to see if any contact information remains visible to the public. It does this by scanning the un-hidden text for symbols and keywords that would give away the presence of a postal or email address or a telephone number. For example, the symbol “@” depicts an email address. A string of characters with “.com” or “.net” depicts a web site. A row of five numbers is checked against zip codes. A row of three numbers in parentheses or next to a row of seven numbers and separated by hyphens is checked against telephone area codes. Words and abbreviations like “road”, “street”, “Ave.”, “St.”, “Blvd”, etc. are also checked against a database of probable matches which would depict a postal address. Words that are capitalized are checked against a database of names. The applet also looks for words like “Phone” or “FAX” and takes into consideration the location of the characters in determining the likelihood of any contact information. This system is not foolproof, but should be able to catch 98% to 99% of the mistakes.

If any of these tests fails, then the user will be instructed to make the corrections and/or finish making selections before proceeding. Otherwise, if the tests are all OK, the coordinates of each rectangle with their respective section are passed along to a backend Servlet for processing via http. Note that all communication between the applet and the Servlet is protected with encryption and verified with session cookies. This is an important point for security reasons.

(4) The Automatic Manipulation of the Document

The Servlet uses the received sets or rectangle coordinates for two purposes. The first purpose is to manipulate the picture of the document and to conceal the parts that are designated by the user as hidden sections. The second purpose is to retrieve the actual text from the SVG version of the document and to store the text from the sections that are not designated as hidden in a searchable field in a database. This will accomplish two important functions:
First, it will create a secured picture of the document that can be viewed by the public.
Second, it will allow the public to perform a search on the text of the secured document.
   (5) Creating the Searchable Database

Behind the scenes, the manipulation process consists of the following steps executed by the Servlet. The Servlet first receives the coordinates from the applet and stores the rectangles in an array for processing. Next, the Servlet loads the SVG version of the document from the database into memory. Then, the Servlet enumerates through each rectangle in the array. For each of these rectangles, the Servlet performs a routine to determine which text from the document lies inside the bounds of the rectangle. If the text is inside the rectangle and the rectangle is not designated as hidden, the text is added to the database for search purposes by the public. This process is repeated until the Servlet has finished enumerating through every rectangle. Upon completion, the document now has a bank of searchable text associated with it that can be searched by the public by use of user-selected keywords.

Note that the searchable text on any particular document can be either classified (i.e. associated) to a heading or combined together to form a single database. If it is classified to a heading, then a search would be confined only to the particular heading specified by the search. This would have the advantage of eliminating false positives from similar words in other sections. The decision of whether to classify the searchable text or combine it into a single database depends ultimately on many factors. Some of these factors are the size of the document, the content of the document, the susceptibility to false positives, the speed of the computer, etc. Each application would have to be decided on a case-by-case basis for best overall performance.

(6) Creating the Secure (Blurred Out) Image

After the Servlet picks out the text to be searched, it moves on to create a secure (i.e. masked) picture of the document. Again the Servlet enumerates through each rectangle, but this time, when it encounters a rectangle that is designated as hidden, it adds the coordinates of that rectangle into the SVG version of the document. So after the Servlet has enumerated through all of the rectangles, it has the SVG document with all of the hidden rectangles added to it. Next, the Servlet applies a filter to the SVG document; a filter is used in this case as a way to conceal (or render indecipherable) the text contained within the hidden rectangles. More specifically, a Gaussian Blur Filter is applied to the document, but only to the coordinates within the bounds of the hidden rectangles. What is produced is an SVG document that has the hidden text blurred out.

In another preferential version of the applet, the characters in the section to be rendered indecipherable are replaced with similar sized random characters prior to the application of the Gaussian Blur Filter. This gives a higher degree of security since it would be impossible to hack into and retrieve the blurred out text. The absolute best one could do is to retrieve the random characters which would make no sense. Whether or not to invoke the random characters depends once again on the particular application and is decided on a case-by-case basis.

Now that we have the secured SVG version of the document, we simply use the same process described in Section 1 to take a snapshot of the secured SVG document. This will produce a purely graphical version of the secured document, with the hidden text blurred out. Since a graphic file is a pure pixilated version, there is no actual text behind the scenes associated with the picture, so the hidden sections are completely secure and unhackable in the picture. A secured picture of each page of the document is now stored in the database.

(7) Distributing the Secure or Sample Version of the Document

Once there is a secured picture of the document stored in the database, it can be distributed as needed to public. The Gaussian blur algorithm used to hide the text in this picture is irreversible and since a picture is not text driven, there is nothing to hack. Therefore, the presented document is now completely secure in its public and viewable form.

(8) Distributing the Disclosed Document

When it is decided (based upon inputs from another web-based application) that an individual or entity has presented the required credentials necessary to gain access to the unmasked version of the document, the PDF version of the document (which was previously stored) can now be released. The PDF version is a full, unmodified version of the document that has all of the hidden information readily displayed. A PDF file is used because it is an industry standard format that is easy to download, easy to save in a computer database, and prints out reliably on most printers. Note that, in other embodiments of the invention, it would be obvious to anyone skilled in the art that it would be possible and may be desirable to store the original document in another text-based format such as but not limited to .doc, .mcw, or .txt, however, this in no way departs from the functionality and spirit of the invention.

While in the preferred embodiment of the invention, we make use of several commercially available programs such as RTF2FO by Novasoft, FOP by Apache, Inc., Batik by Apache, Inc., and so on to make the conversion from one type of file format to another where it can be processed, it would be obvious to anyone skilled in the art to recognize that other commercially available programs or embedded “custom made” proprietary programs would work just as well and could just as easily be used without departing from the spirit and functionality of the invention. The important point is to keep in mind the purposes and accomplishments of the present invention which include:
(1) Method of extracting information directly from an uploaded document over an Internet link solely by use of a computer mouse (click and drag).
(2) Method of creating a searchable database over an Internet link directly from a document uploaded and stored in the server without necessitating the filling in of any text boxes or forms.
(3) Method of associating certain highlighted information on a resume with searchable categories to reduce the incidence of false positives. (e.g. a search for keywords related to education could be confined to the category called “Education”.
(4) Method of displaying a resume over the Internet such that the “look and feel” of the resume is maintained while confidential information is rendered indecipherable.
(5) Method of masking out sections of any document such that the “look and feel” of the document is maintained but the text is rendered indecipherable and impossible to reverse or decode.
(6) Method of inserting random characters in selected sections of a resume such that the information contained there is rendered indecipherable.
(7) Method of automatically and without human input identifying contact information contained in a resume and warning the user or rendering indecipherable with a computer program.
(8) Method of retrieving the masked out information on a document and re-creating the original document over an Internet link.

To aid in the understanding of the present invention, the following list of definitions and Appendix of exhibits are provided and incorporated to illustrate the best embodiment of the invention:

Definitions

(1) www World Wide Web
(2) RTF Rich Text Format
(3) HTML HyperText Markup Language
(4) PDF Portable Document Format (Adobe Systems Inc. Format)
(5) SVG Scalable Vector Graphics
(6) GUI Graphical User Interface
(7) PAYPAL An Internet based payment service.
(8) XML Extensible Markup Language
(9) FO Formatting Object
(10) Plug-in A very small program that adds a specific feature to a web browser.
(11) Applet A program that is designed to run inside of a larger program and perform a specific function for the larger program.
(12) Cookies Very short web-based strings of text that hold certain types of information for future use like user name, ID number, etc. Note that there is no limitation on the length of cookies although they are generally less than 50 characters long.

### Appendix oF Exhibits

Exhibits:

(1) Block diagram of typical system.
(2) Flow chart of Applet.
   a. Document Classifying & Storage System—Upload and Conversion Process
   b. Document Classifying & Storage System—Classifying Process
   c. Document Classifying & Storage System—Automatic Manipulation
(3) Image of blurred out sample resume.
(4) Image of same resume as above but without masking.
(5) Image of Create Resume Sections screen.
(6) Image of Initialize Resume screen.

The following programs which are the subject of the identified copyright registrations are incorporated in their entirety by reference:

Copyright Registration No. TXu-1-219-281 “Applet Defining a Web-based Method of Rendering Indecipherable Selected Parts of a Document and Creating a Searchable Database from the Text”, registered Jan. 3, 2005;
AND

Copyright Registration No. TXu-1-219-282“Method of Displaying a Resume Over the Internet in a Secure Manner,” registered Jan. 3, 2005.

While the invention has been described with regard to a preferred embodiment, i.e. one in which the job candidate loads his resume into the facilitator server in Rich text format, there is also significant advantage to having the program adapted so that the job candidate may load its resume in any of the other common word processing document formats, for example, Microsoft Word, Clarice Works, WordPerfect, Lotus, and the like, with MS-Word being of particular significance because of its prevalence among computer users. These common word processing document formats can be converted into XML format or PDF format by any one or more of the readily available “tools” adapted to run the major platforms. These “tools” include OpenOffice, AbiWord, Antenna House Server-based Converter V1.2, Microsoft Windows, GNU/Linux, Sun Solaris, Mac OS X, or “Free BSD.” These various programs will permit conversion of the uploaded product into either XML format or PDF format, which can then be converted into SVG format. Accordingly, the invention is not limited to the use of the standard RTF text file format.

What is claimed:

1. A method for rendering indecipherable selected parts of a document and creating a searchable database from the test comprising the steps of:
A. Uploading a document into a server in a word-processing document format convertible into XML or PDF format;
B. Converting the uploaded product of Step A into XML or PDF format;
C. Converting the XML-formatted or PDF-formatted product of Step B into SVG format;
D. Rendering the SVG-formatted product of Step C as a pure pixilated graphics file;
E. Saving on the server the SVG-formatted document and pixilated files of Steps C and D in a database for storage;
F. Presenting to the uploader of Step A the pixilated results of Steps D and E in graphical user interface;
G. The uploader of Step A classifies by coordinates and dimensions of the pixilated files one or more section of the presented product of Step F to be hidden from public view, and stores each such section in a data base;
H. The classified information and saved files of the database of Step G are processed by the server to conceal the section of pixilated files to be hidden and coordinating same with corresponding text found in the SVG documents; and
I. Generating a list of unhidden text and storing such information as searchable information in a searchable data base for access by internet users.

2. A method for rendering indecipherable selected parts of a document and creating a searchable database from the test comprising the steps of:
A. Uploading a document into a server in Rich Text format;
B. Converting the uploaded product of Step A into XML format;
C. Converting the XML-formatted product of Step B into SVG format;
D. Rendering the SVG-formatted product of Step C as a pure pixilated graphics file;
E. Saving on the server the SVG-formatted document and pixilated files of Steps C and D in a database for storage;
F. Presenting to the uploader of Step A the pixilated results of Steps D and E in graphical user interface;
G. The uploader of Step A classifies by coordinates and dimensions of the pixilated files one or more section of the presented product of Step F to be hidden from public view, and stores each such section in a data base;
H. The classified information and saved files of the database of Step G are processed by the server to conceal the section of pixilated files to be hidden and coordinating same with corresponding text found in the SVG documents; and
I. Generating a list of unhidden text and storing such information as searchable information in a searchable data base for access by internet users.
